(19) United States
(12) Patent Application Publication
(10) Pub. No.: US 2017/0337027 A1
(43) Pub. Date: Nov. 23, 2017

(54) DYNAMIC CONTENT MANAGEMENT OF A VEHICLE DISPLAY

(71) Applicant: Google Inc., Mountain View, CA (US)

(72) Inventors: Victor Chan, Fremont, CA (US); Andrews-junior Kimbembe, Mountain View, CA (US); Andrew Stewart, San Francisco, CA (US); Evan Nicklas Wu Malahy, Sunnyvale, CA (US); Rakesh Narayan Iyer, Santa Clara, CA (US); Joel Roger Beukelman, Costa Mesa, CA (US)

(21) Appl. No.: 15/333,690

(22) Filed: Oct. 25, 2016

Related U.S. Application Data
(60) Provisional application No. 62/337,719, filed on May 17, 2016.

(51) Int. Cl. G06F 3/14; G06F 3/0481; G09G 5/38

(52) U.S. Cl. CPC G06F 3/1423; G09G 5/38; G06F 3/0481; G06F 2203/04803

(57) ABSTRACT

A method includes outputting, by an information system of a vehicle, for display at a first portion of a display device located at a center console of the information system, a first graphical user interface (GUI) associated with an active application from a plurality of applications. The method includes determining, by the information system, respective relevancy scores of two or more applications from the plurality of applications other than the active application. Each respective relevancy scores indicates a probability that the application will be of interest to a driver of the vehicle while the first GUI is being output for display. The method includes determining, by the information system, based on the respective relevancy scores, a highest ranked application from the two or more applications, and outputting, by the information system, for display at a second portion of the display device, a second GUI associated with the highest ranked application.

The application claims the benefit of U.S. Provisional Application No. 62/337,719, filed May 17, 2016, the entire contents of which is incorporated by reference herein.

### BACKGROUND

Some vehicles (e.g., automobiles, motorcycles, aircraft, marine craft, and the like) may augment or even replace traditional gauges and control switches with graphical displays (e.g., as part of a dashboard, headrest, gauge cluster, safety mirror, etc.) for presenting information to occupants of the vehicle. For example, an information system of an automobile may output a graphical user interface at such a display to enable user interactions with navigation, communication, entertainment, or other non-safety critical features of the automobile.

As vehicle information systems evolve, the screen size of information system displays is increasing. Many vehicles now include multiple, large sized, displays that are capable of simultaneously displaying a large amount of rich and complex content. While some occupants may enjoy being able to access many features of the vehicle information system simultaneously, presenting too much information and/or presenting the information in a complex manner can be especially harmful to the act of driving. For example, a driver may have difficulty finding a particular piece of information or controlling a particular feature from amongst all the information being presented across one or more displays. Such difficulty may distract the driver or otherwise impede his or her ability to safely operate the vehicle.

### SUMMARY

In one example, the disclosure is directed to a method that includes outputting, by an information system of a vehicle, for display at a first portion of a display device located at a center console of the information system, a first graphical user interface (GUI) associated with an active application from a plurality of applications; determining, by the information system, respective relevancy scores of two or more applications from the plurality of applications other than the active application, wherein each respective relevancy scores indicates a probability that the application will be of interest to a driver of the vehicle while the first GUI is being output for display; determining, by the information system, based on the respective relevancy scores, a highest ranked application from the two or more applications; and outputting, by the information system, for display at a second portion of the display device, a second GUI associated with the highest ranked application.

In another example, the disclosure is directed to a vehicle information system comprising a computing device. The computing device includes a display device located at a center console of the vehicle information system, at least one processor; and a memory. The memory includes instructions that, when executed by the at least one processor, cause the at least one processor to: output, for display at a first portion of the display device, a first graphical user interface (GUI) associated with an active application from a plurality of applications; determine respective relevancy scores of two or more applications from the plurality of applications other than the active application, wherein each respective relevancy scores indicates a probability that the application will be of interest to a driver of the vehicle while the first GUI is being output for display; determine, based on the respective relevancy scores, a highest ranked application from the two or more applications; and output, for display at a second portion of the display device, a second GUI associated with the highest ranked application.

In another example, the disclosure is directed to a computer-readable storage medium encoded with instructions that, when executed by at least one processor of a computing device, cause the at least one processor to: output, for display at a first portion of a display device located at a center console of an information system of a vehicle, a first graphical user interface (GUI) associated with an active application from a plurality of applications; determine respective relevancy scores of two or more applications from the plurality of applications other than the active application, wherein each respective relevancy scores indicates a probability that the application will be of interest to a driver of the vehicle while the first GUI is being output for display; determine based on the respective relevancy scores, a highest ranked application from the two or more applications; and output, for display at a second portion of the display device, a second GUI associated with the highest ranked application.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example vehicle information system that is configured to dynamically manage what and where information is presented to occupants of a vehicle, in accordance with one or more aspects of the present disclosure.

FIG. 2 is a block diagram illustrating an example vehicle information system that is configured to dynamically manage what and where information is presented to occupants of a vehicle, in accordance with one or more aspects of the present disclosure.

FIG. 3 is a conceptual diagrams illustrating an example vehicle information system that is configured to dynamically manage what and where information is presented to occupants of a vehicle, in accordance with one or more aspects of the present disclosure.

FIG. 4 is a flowchart illustrating example operations of a vehicle information system that is configured to dynamically manage what and where information is presented to occupants of a vehicle, in accordance with one or more aspects of the present disclosure.

FIGS. 5A-5C are conceptual diagrams illustrating example graphical user interfaces output by an example vehicle information system that is configured to dynamically manage what and where information is presented to occupants of a vehicle, in accordance with one or more aspects of the present disclosure.

### DETAILED DESCRIPTION

In general, this disclosure is directed to techniques for enabling a vehicle information system to dynamically manage what and where information is presented to occupants of a vehicle. The vehicle information system may simultaneously execute and display information associated with multiple applications, with each application providing different information that an occupant may wish to see at any given time. The vehicle information system may present a graphical user interface (GUI) of a primary or “active” application at one location of a display as well as information associated with one or more secondary applications at a different location or different display.

While a user may manually select the primary or active application for presentation at a particular time, the vehicle information system may automatically determine (e.g., so as to allow a driver to remain focused on driving the vehicle) what information associated with one or more secondary applications is most likely to be of interest to the driver at the particular time. The vehicle information system may rank the secondary applications based on a current context (e.g., of the vehicle and/or information already being displayed by the primary or active application) and may output information associated with the one or more highest ranking secondary applications.

In addition to automatically selecting what secondary application information to show at any given time, the vehicle information system may also automatically determine where to show it. For example, the vehicle information system may automatically choose a display and a location of a display to present the information of a secondary application that has a greater chance of being consumed by the driver without impeding the driver from obtaining other important information being displayed elsewhere, being too distracting, or otherwise impacting his or her driving.

In this way, techniques of this disclosure may enable a vehicle information system to automatically select and output information from multiple secondary applications that compliments information already being presented with a primary or active application that is selected by a user. By automatically presenting secondary application information in this way, the techniques of this disclosure may enable the vehicle information system to make it easy for the driver to locate information that may be most relevant to a current context. By making it easier for the driver to locate relevant information for the current context, the vehicle information system may reduce the effort required by the user to consume information, which may increase the safety of the driver and other people on the road.

Throughout the disclosure, examples are described in which a computing device and/or a computing system may analyze information (e.g., locations, speeds, etc.) associated with a computing device only if the computing device receives permission from the user to analyze the information. For example, in situations discussed below in which the computing device may collect or may make use of information associated with the user, the user may be provided with an opportunity to provide input to control whether programs or features of the computing device can collect and make use of user information (e.g., information about a user's current location, current speed, etc.), or to dictate whether and/or how to the computing device may receive content that may be relevant to the user. In addition, certain data may be treated in one or more ways before it is stored or used by the computing device and/or computing system, so that personally identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device.

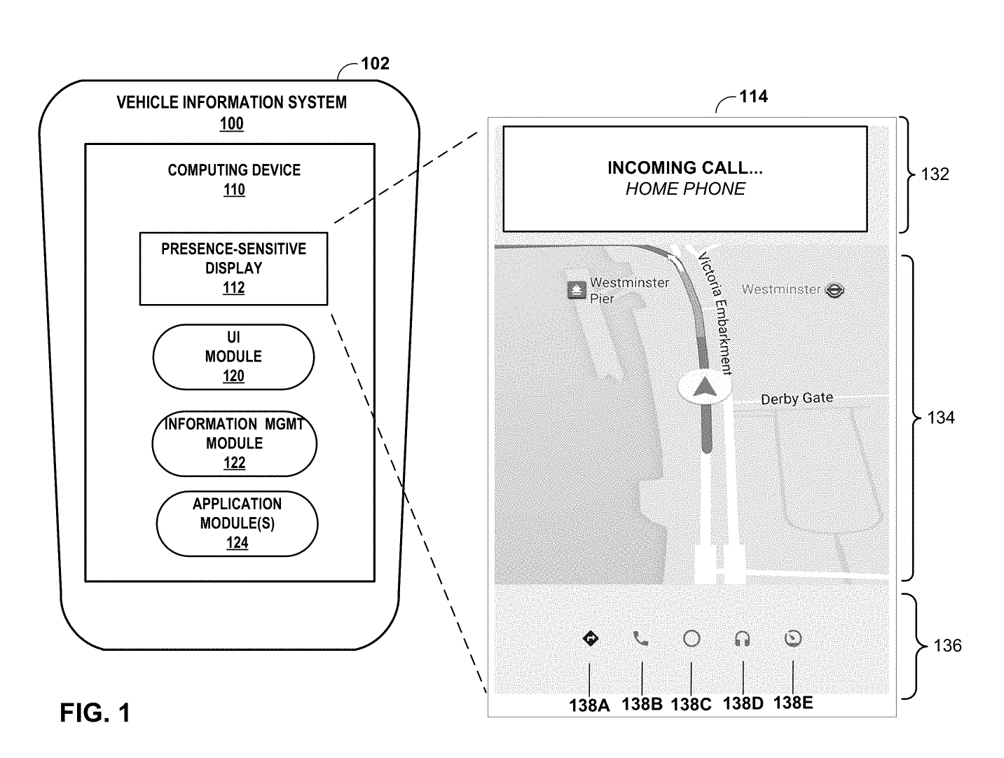

FIG. 1 is a conceptual diagram illustrating an example vehicle information system that is configured to dynamically manage what and where information is presented to occupants a vehicle, in accordance with one or more aspects of the present disclosure. While described primarily as included as part of a vehicle, such as an automobile, motorcycle, aircraft, or watercraft, vehicle information system 100 may also be included or part of any non-vehicle system in which dynamic management of information presentation is useful (e.g., home automation, home entertainment system, manufacturing control systems, etc.). Vehicle information system 100 in the example of FIG. 1 may be integrated as part of an automobile dashboard or console facing the occupants of the vehicle. Vehicle information system 100 may be directly and physically accessible to occupants seated in the front driver seat of the automobile. In some examples, vehicle information system 100 may be positioned in the automobile dashboard or center console between a driver and passenger seat. For instance, vehicle information system 100 may be centered between a driver and passenger seat in the automobile dashboard or center console.

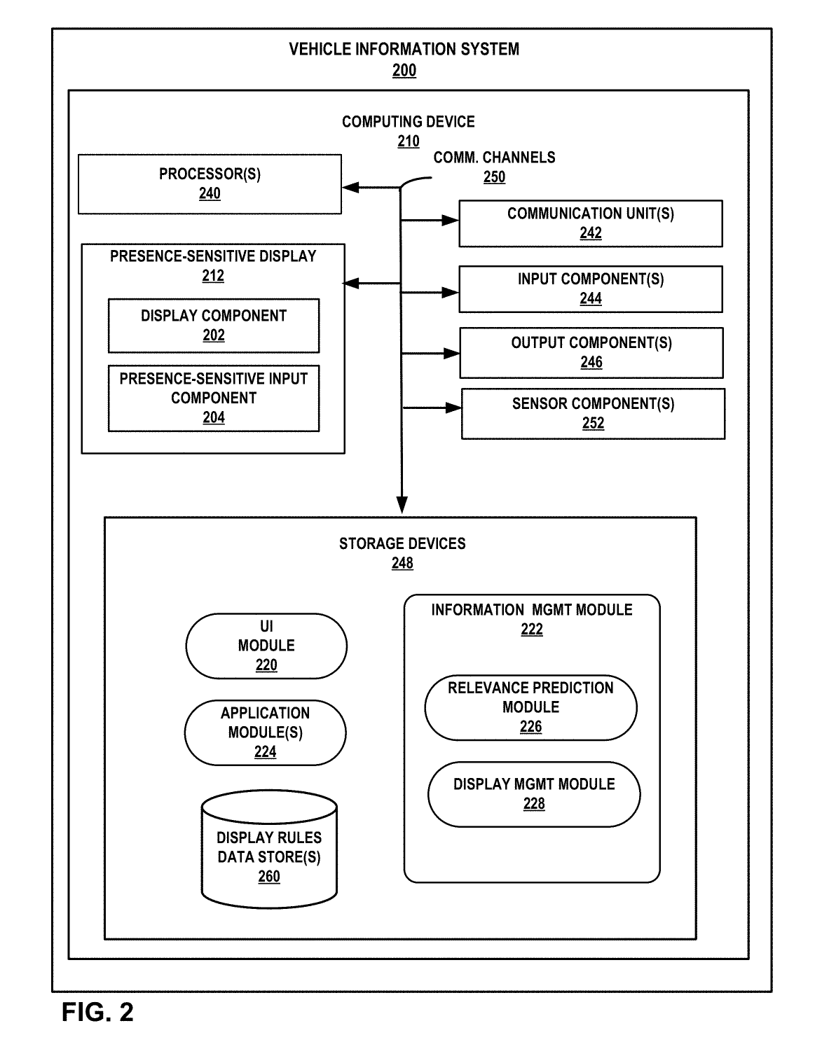

Vehicle information system 100 may include a housing 102 and computing device 110. Housing 102 may in some examples be constructed of plastic, aluminum, steel, or any other suitable material. Housing 102 may be a rigid case that encloses and otherwise protects electrical components that provide the functionality of vehicle information system 100. In some examples, housing 102 may be affixed, mounted or otherwise integrated with the automobile dashboard or console. Vehicle information system 100 may also include a computing device 110 that provides an operating environment for one or one more modules, such as user-interface (UI) module 120, information management module (IMM) 122, and one or more application modules 124. In some examples, computing device 110 may comprise a combination of hardware and software, as further illustrated in FIG. 2. For instance, computing device 110 may include presence-sensitive display 112, one or more processors, and one or more storages devices that may execute instructions and store data of one or more modules. Computing device 110 may also be operably coupled to one or more other software and/or hardware components to control, configure, and/or communicate information with the components, to name only a few example operations.

Vehicle information system 100 may be referred to as an “infotainment system” and be configured to provide information to assist, inform, and entertain occupants of a vehicle. For example, vehicle information system 100 may execute one or more applications (e.g., application modules 124) that provide user interfaces from which one or more occupants can control functionality of the vehicle. For instance, vehicle information system 100 may provide a navigation service that provides directions to destinations, an information retrieval service that provides information in response to queries and/or as preemptive assistance or recommendations, vehicle data about the vehicle, or multimedia such as audio or video, to name only a few examples. In this way, vehicle information system 100 may provide information that generally improves the driving or riding experience for one or more occupants of the vehicle.

Computing device 110 includes a presence-sensitive display (PSD) 112, user interface (UI) module 120, information management module (IMM) 122, and one or more application modules 124. Modules 120, 122, and 124 may perform operations described using software, hardware, firmware, or a mixture of hardware, software, and firmware residing in and/or executing at computing device 110. Computing device 110 may execute modules 120, 122, and 124 with multiple processors or multiple devices. Computing device 110 may execute modules 120, 122, and 124 as virtual machines executing on underlying hardware. Modules 120, 122, and 124 may execute as one or more services of an operating system or computing platform. Modules 120, 122, and 124 may execute as one or more executable programs at an application layer of a computing platform.

PSD 112 of computing device 110 may function as respective input and/or output devices for computing device 110. PSD 112 may be implemented using various technologies. For instance, PSD 112 may function as input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. PSD 112 may also function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing device 110.

PSD 112 may receive tactile input from a user of computing device 110. PSD 112 may receive indications of tactile input by detecting one or more gestures from a user (e.g., the user touching or pointing to one or more locations of PSD 112 with a finger or a stylus pen). PSD 112 may output information to a user as a graphical user interface (e.g., graphical user interface 114), which may be associated with functionality provided by computing device 110. For example, PSD 112 may present various graphical user interfaces of applications (e.g., a navigation application) executing at computing device 110. A user of vehicle information system 100 may provide user input at presence-sensitive input device of PSD 112 to interact with one or more of these applications.

UI module 120 manages user interactions with PSD 112 and other components of computing device 110. For example, UI module 120 may output a graphical user interface and may cause PSD 112 to display the graphical user interface as a user of computing device 110 views output and/or provides input at PSD 112. UI module 120 may receive one or more indications of input from a user as the user interacts with the graphical user interfaces (e.g., PSD 112). UI module 120 may interpret inputs detected at PSD 112 and may relay information about the detected inputs to one or more associated platforms, operating systems, applications, and/or services executing at computing device 110, for example, to cause computing device 110 to perform functions.

In some examples, UI module 120 may cause PSD 112 to present graphical user interface 114. Graphical user interface 114 includes graphical elements displayed at various locations of PSD 112. For example, as illustrated in FIG. 1, graphical user interface 114 includes a plurality of regions, including secondary application region 132, primary application region 134, and icon region 136. Icon region 136 includes icons that represent applications or functions of the computing device. For example, icon region 136 may include a mapping or navigation icon 138A, a phone icon 138B, a home screen icon 138C, a music icon 138D, and a vehicle diagnostics icon 138E. In some examples, icon region 136 may include additional or fewer icons.

UI module 120 may receive information and instructions from one or more associated platforms, operating systems, applications, and/or services executing at computing device 110 and/or one or more external computing systems. In addition, UI module 120 may act as an intermediary between the one or more associated platforms, operating systems, applications, and/or services executing at computing device 110, various output devices of computing device 110 (e.g., speakers, LED indicators, audio or electrostatic haptic output device, etc.) to produce output (e.g., a graphic, a flash of light, a sound, a haptic response, etc.) with computing device 110.

Application modules 124 represent all the various individual applications and services that may be executing at computing device 110 at any given time. A user of computing device 110 may interact with an interface (e.g., graphical user interface 114) associated with one or more application modules 124 to cause computing device 110 to perform a function. Numerous examples of application modules 124 may exist and include, a mapping or navigation application, a calendar application, a personal assistant or prediction engine, a search application, a transportation service application (e.g., a bus or train tracking application), a social media application, a game application, an e-mail application, a messaging application, an Internet browser application, or any and all other applications that may execute at computing device 110.

Computing device 110 may receive an indication of user input corresponding to a command associated with an application of applications 124. For example, a user of computing device 110 may speak the command “Give me directions to the nearest zoo.” A microphone of computing device 110 may detect the user input and UI module 120 may receive an indication of the audio command from the microphone. UI module 120 may output information about the audio input to IMM 122. In other examples, a user of computing device may provide one or more user inputs at a location(s) of PSD 112. For example, a user may type in an address. UI module 120 may receive an indication of the user input from PSD 112 and may output information about the touch input to IMM 122.

IMM 122 may interact with UI module 120 to manage the information displayed by PSD 112. For example, responsive to receiving the information about the user input (e.g., an audio input, touch input, or other type of user input), IMM 122 may determine an application associated with the user input. For example, IMM 122 may determine that the user input includes a command for directions and cause computing device 110 to execute or open a mapping or navigation application. IMM 122 may determine that, because there are no other applications currently running, the navigation application should be prominently displayed at active application region 134 of graphical user interface 114. IMM 122 may output an indication of the navigation application and the location of the UI at which the navigation application should be displayed. UI module 120 may receive the indication of the navigation application and the indication of the location at which the application is to be displayed, and may generate a graphical user interface 114 that includes a graphical user interface associated with the navigation application at active application region 134. UI module 120 may output graphical user interface 114 causing PSD 112 to display the graphical user interface.

Computing device 110 may receive information associated with one or more applications other than the active (e.g., navigation) application. For example, computing device 110 may receive information associated with a communication application (e.g., a call, a text, or an email), multimedia (e.g., new, music, or video) applications, traffic applications, weather applications, or any other type of application.

In some examples, computing device 110 may receive information associated with two or more applications other than the active application, and IMM 122 may determine which information to display. IMM 122 may determine which information to display by determining a respective relevancy score for each of the two or more applications. Each relevancy score may indicate a probability that a respective application will be of interest to the driver of the vehicle while the first graphical user interface is output for display. In some examples, IMM 122 may determine the relevancy score of each application based on a type of the application, a context of the active application, a context of each application of the two or more applications, a context of the vehicle, or a combination therein. In some examples, IMM 122 may also determine the relevancy score based at least in part on information associated with the application. For example, an application may specify that the information associated with the application is very important, which may cause IMM 122 to increase the relevancy score associated with the application.

Responsive to determining the respective relevancy scores for each application of the two or more applications, IMM 122 may determine the highest ranking application from the two or more applications. For example, IMM 122 may sort the applications by relevancy score from largest relevancy score to smallest relevancy score, and may determine that the highest ranking application is the application with the largest relevancy score. For example, if computing device 110 receives information associated with a news application and information associated with a phone application, IMM 122 may determine that the relevancy score associated with the phone application is greater than the relevancy score associated with the news application.

IMM 122 may send an indication of the highest ranked application to UI module 120. UI module 120 may receive the indication of the highest ranked application, generate a graphical user interface associated with the highest ranked application, and may output the graphical user interface to PSD 112. For example, as illustrated by FIG. 1, UI module 120 may receive an indication of a phone application from IMM 122 and may generate a graphical user interface associated with the phone application. UI module 120 may output the graphical user interface and may cause PSD 120 to display the graphical user interface associated with the phone application at secondary application region 134 of user interface 132.

Techniques of this disclosure may enable a vehicle information system to receive information associated with two or more applications and determine a relevancy score associated with each of the applications for which data has been received. The relevancy score may indicate the probability that the information associated with the application will be of interest to the driver of the vehicle. By determining the relevancy score of each application for which information has been received, the vehicle information system may rank the applications and select the application having the highest relevancy score. The vehicle information system may output the information associated with the highest ranked application. By outputting the information associated with the highest ranked application, the techniques of this disclosure may enable the vehicle information system to output the most relevant information to the user at a location that makes it easy for the driver to locate the information. By making it easier for the driver to locate relevant information, the vehicle information system may reduce the effort required by the user to find information, which may increase the safety of the driver and other people on the road.

Throughout the disclosure, examples are described in which a computing device and/or a computing system may analyze information (e.g., locations, speeds, etc.) associated with a computing device only if the computing device receives permission from the user to analyze the information. For example, in situations discussed below in which the computing device may collect or may make use of information associated with the user, the user may be provided with an opportunity to provide input to control whether programs or features of the computing device can collect and make use of user information (e.g., information about a user's current location, current speed, etc.), or to dictate whether and/or how to the computing device may receive content that may be relevant to the user. In addition, certain data may be treated in one or more ways before it is stored or used by the computing device and/or computing system, so that personally identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device.

FIG. 2 is a block diagram illustrating an example vehicle information system that is configured to dynamically manage what and where information is presented to occupants of a vehicle, in accordance with one or more aspects of the present disclosure. Vehicle information system 200 of FIG. 2 is described below as an example of vehicle information system 100 illustrated in FIG. 1. FIG. 2 illustrates only one particular example of a vehicle information system. Many other examples of a vehicle information system may be used in other instances, which may include a subset of the components included in example vehicle information system 200 or may include additional components not shown in FIG. 2.

Vehicle information system 200 may include computing device 210. As shown in the example of FIG. 2, computing device 210 includes PSD 212, one or more processors 240, one or more communication units 242, one or more input components 244, one or more output components 246, one or more storage components 248, and one or more sensors 252. PSD 212 includes display component 202 and presence-sensitive input component 204. Storage components 248 of computing device 210 may include UI module 220, IMM 222, and one or more application modules 224. Additionally, storage components 248 are configured to store display rules data store 260. IMM 222 may include relevance prediction module (RPM) 226 and display management module (DMM) 228. Communication channels 250 may interconnect each of the components 212, 240, 242, 244, 246, 248, and 252 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on the one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

In some examples, communication units 242 may communicate with an electronic control unit (ECU) of the vehicle or any other sensor or component of the vehicle (e.g., via a controller area network (CAN) bus). For example, a vehicle may include sensors to detect speed, acceleration, location (e.g., GPS), open doors or windows, energy levels (e.g., an amount of charge in a battery, or an amount of fuel such as gasoline, diesel fuel, or liquid hydrogen), or any other information about the vehicle. Computing device 210 may receive such “vehicle” information from the ECU via communication unit 242.

One or more input components 244 of computing device 210 may receive input. Examples of input are tactile, audio, and video input. Input components 242 of computing device 210, in one example, includes a presence-sensitive input device (e.g., a touch sensitive screen, a PSD), mouse, keyboard, voice responsive system, video camera, microphone or any other type of device for detecting input from a human or machine.

One or more output components 246 of computing device 110 may generate output. Examples of output are tactile, audio, and video output. Output components 246 of computing device 210, in one example, includes a PSD, sound card, video graphics adapter card, speaker, cathode ray tube (CRT) monitor, liquid crystal display (LCD), or any other type of device for generating output to a human or machine.

As shown in FIG. 2, computing device 210 may include one or more sensor components 252. Sensor components 252 may include an accelerometer that generates accelerometer data. Accelerometer data may indicate an acceleration and/or a change in acceleration of computing device 210. Sensor components 252 may include a gyrometer that generates gyrometer data. Gyrometer data may indicate a physical orientation and/or change in physical orientation of computing device 210. In some examples, the orientation may be relative to one or more reference points. Sensor components 252 may include a magnetometer that generates magnetometer data. Magnetometer data may indicate the magnetization of an object that is touching or in proximity to computing device 210. Magnetometer data may indicate the Earth's magnetic field, and in some examples, provide directional functionality of a compass. Sensor components 252 may include an ambient light sensor that generates ambient light data. The ambient light data may indicate an intensity of light to which computing device 210 is exposed. Sensor components 252 may include a proximity sensor that generates proximity data. Proximity data may indicate whether an object is within proximity to computing device 210. In some examples, sensor components 252 may include a clock that generates a date and time. The date and time may be a current date and time. Sensor components 252 may include temperature sensor that measures ambient temperature in proximity to sensor components 252. The ambient temperature may indicate an intensity of temperature. Sensor components 252 may include radar or lidar.

PSD 212 of computing device 210 includes display component 202 and presence-sensitive input component 204. Display component 202 may be a screen at which information is displayed by PSD 212 and presence-sensitive input component 204 may detect an object at and/or near display component 202. As one example range, presence-sensitive input component 204 may detect an object, such as a finger or stylus that is within two inches or less of display component 202. Presence-sensitive input component 204 may determine a location (e.g., an [x, y] coordinate) of display component 202 at which the object was detected. In another example range, presence-sensitive input component 204 may detect an object six inches or less from display component 202 and other ranges are also possible. Presence-sensitive input component 204 may determine the location of display component 202 selected by a user's finger using capacitive, inductive, and/or optical recognition techniques. In some examples, presence-sensitive input component 204 also provides output to a user using tactile, audio, or video stimuli as described with respect to display component 202. In the example of FIG. 2, PSD) 212 may present a graphical user interface (such as graphical user interface 114A for receiving text input and outputting a character sequence inferred from the text input as shown in FIG. 1).

While illustrated as an internal component of computing device 210, PSD 212 may also represent and an external component that shares a data path with computing device 210 for transmitting and/or receiving input and output. For instance, in one example, PSD 212 represents a built-in component of computing device 210 located within and physically connected to the external packaging of computing device 210 (e.g., a screen on a mobile phone). In another example, PSD 212 represents an external component of computing device 210 located outside and physically separated from the packaging or housing of computing device 210 (e.g., a monitor, a projector, etc. that shares a wired and/or wireless data path with computing device 210).

PSD 212 of computing device 210 may receive tactile input from a user of computing device 210. PSD 212 may receive indications of the tactile input by detecting one or more tap or non-tap gestures from a user of computing device 210 (e.g., the user touching or pointing to one or more locations of PSD 212 with a finger or a stylus pen). PSD 212 may present output to a user. PSD 212 may present the output as a graphical user interface (e.g., graphical user interfaces 114 of FIG. 1), which may be associated with functionality provided by various functionality of computing device 210. For example, PSD 212 may present various graphical user interfaces of components of a computing platform, operating system, applications, or services executing at or accessible by computing device 210 (e.g., an electronic message application, a navigation application, an Internet browser application, a mobile operating system, etc.). A user may interact with a respective graphical user interface to cause computing device 210 to perform operations relating to one or more the various functions. For example, IMM 222 may cause PSD 212 to present a graphical user interface associated with an application 224 of computing device 210.

PSD 212 of computing device 210 may detect two-dimensional and/or three-dimensional gestures as input from a user of computing device 210. For instance, a sensor of PSD 212 may detect a user's movement (e.g., moving a hand, an arm, a pen, a stylus, etc.) within a threshold distance of the sensor of PSD 212. PSD 212 may determine a two or three dimensional vector representation of the movement and correlate the vector representation to a gesture input (e.g., a hand-wave, a pinch, a clap, a pen stroke, etc.) that has multiple dimensions. In other words, PSD 212 can detect a multi-dimension gesture without requiring the user to gesture at or near a screen or surface at which PSD 212 outputs information for display. Instead, PSD 212 can detect a multi-dimensional gesture performed at or near a sensor which may or may not be located near the screen or surface at which PSD 212 outputs information for display.

One or more processors 240 may implement functionality and/or execute instructions associated with computing device 210. Examples of processors 2410 include application processors, display controllers, auxiliary processors, one or more sensor hubs, and any other hardware configure to function as a processor, a processing unit, or a processing device. Modules 220, 222, 224, 226, and 228 may be operable by processors 240 to perform various actions, operations, or functions of computing device 210. For example, processors 240 of computing device 210 may retrieve and execute instructions stored by storage components 248 that cause processors 240 to perform the operations modules 220, 222, 224, 226, and 228. The instructions, when executed by processors 240, may cause computing device 210 to store information within storage components 248.

One or more storage components 248 within computing device 210 may store information for processing during operation of computing device 210 (e.g., computing device 210 may store data accessed by modules 220, 222, 224, 226, and 228 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220, 222, 224, 226, and 228, as well as data store 260. Storage components 248 may include a memory configured to store data or other information associated with modules 220, 222, 224, 226, and 228, as well as data stores 260.

Application modules 224 represent all the various individual applications and services executing at and accessible from computing device 210. A user of computing device 210 may interact with an interface (e.g., a graphical user interface) associated with one or more application modules 224 to cause computing device 210 to perform a function.

UI module 220 may include all functionality of UI module 120 of computing device 110 of FIG. 1 and may perform similar operations as UI module 120 for managing a graphical user interface (e.g., graphical user interface 114) that computing device 210 provides at PSD 212 for handling input from a user. In some examples, UI module 220 may detect one or more user inputs at PSD 212 and may output information about the user inputs to IMM 222. For example, UI module 220 may detect an initial user input selecting an application icon (e.g., navigation icon 138A of FIG. 1). Responsive to detecting the user input selecting the application icon, UI module 220 may output information about the user input to IMM 222. IMM 222 may receive the information about the user input and may determine that because no other applications are currently running, the navigation application will be an active application and should be prominently displayed at a primary application region 134 of the graphical user interface. IMM 122 may reply to UI module 220 with a command to generate a graphical user interface associated with the navigation application at the primary application region 134. UI module 220 may receive the data associated with the navigation application over communication channels 250 and use the data to generate a graphical user interface. UI module 220 may transmit a display command and data over communication channels 250 to cause PSD 212 to present the graphical user interface at PSD 212. As a result, PSD 212 may display a graphical user interface (e.g., graphical user interface 114 of FIG. 1) that includes information associated with the active application (e.g., the navigation application) at primary application region 134 of FIG. 1.

Communication units 242 may receive information associated with at least one of the plurality of applications 224 installed at storage devices 248. For example, communication units 242 may receive sports information associated with a sports news application (e.g., a scoring update for a baseball game) and may receive communication information associated with a messaging application (e.g., a text message).

IMM 222 may include all functionality of IMM 122 of computing device 110 of FIG. 1 and may perform similar operations as IMM 122 for managing a graphical user interface that computing device 210 provides at PSD 212. IMM 222 may include various submodules, such as RPM 226, and DMM 228, which may perform the functionality of IMM 222. For example, responsive to receiving the information associated with the sports news application and the communication information associated with a messaging application, RPM 226 may determine which information to display and DMM 228 may determine where to display the information.

In some examples, RPM 226 may determine which information to display by determining a respective relevancy score for each application associated with the information received by communication units 242. Each relevancy score may indicate a probability that a respective application will be of interest to the driver of the vehicle while the first graphical user interface is output for display.

In some examples, RPM 226 may determine the respective relevancy score for each application based on a type of the application. The type of application may include a transportation application, a communication application, a multimedia application, or any and all other applications that may execute at computing device 210. In some examples, a transportation application may include an application that provides traffic information, a navigation application that provides route information, or the like. A communication application may include a phone application, a messaging application (e.g., SMS, MMS, or email), or the like. A multimedia application may include a calendar application, a personal assistant or prediction engine, a social media application, a game application, an Internet browser application, or the like. In some examples, each application may include a type identifier that identifies the type of application. RPM 226 may receive an indication of the application type from the respective application and may query display rules data store 260 to determine a relevancy score associated with each application.

Display rules data stores 260 may include one or more databases that represent rules for determining relevancy scores for each application 224. For example, display rules data stores 260 may include a predefined ranking of application types, which may include a score associated with each type of application. RPM 226 may compare the type identifier indicated by each application to the predefined ranking of application types within display rules data store 260 and may assign a relevancy score as indicated by the predefined ranking.

In some examples, RPM 226 may determine the respective relevancy score for each application based on contextual information. Contextual information may include the context of the active application, the context of the two or more applications, the context of the vehicle, or contextual information associated with the driver of the vehicle. In some examples, contextual information may be stored at computing device 210 or at a remote device (e.g., a remote server or a user's cell phone).

When computing devices store contextual information associated with individual users or when the information is genericized across multiple users, all personally-identifiable-information such as name, address, telephone number, and/or e-mail address linking the information back to individual people may be removed before being stored. Computing device 210 and/or a remote device may further encrypt the information to prevent access to any information stored therein. In addition, computing devices may only store information associated with users of computing devices if those users affirmatively consent to such collection of information. The computing devices may further provide opportunities for users to withdraw consent and in which case, the computing devices may cease collecting or otherwise retaining the information associated with that particular user.

As used throughout the disclosure, the term “contextual information” is used to describe information that can be used by a computing system and/or computing device, such as computing device 210 to define one or more environmental characteristics associated with computing devices and/or users of computing devices. In other words, contextual information represents any data that can be used by a computing device and/or computing system to determine a “user context” indicative of the circumstances that form the experience the user undergoes (e.g., virtual and/or physical) for a particular location at a particular time.

In some examples, the context of the active application may include information associated with the active application that was recently displayed or is currently being displayed, how long the active application has been active, etc. For example, if the active application is a traffic and navigation application and the active application currently displays that the driver should remain on the same road for another 10 miles, RPM 226 may determine that the context of the active application indicates that the active application is not likely to be of interest to the driver, such that RPM 226 may assign a low relevancy score to the navigation application (e.g., 20 out of 100). In another example, if the active application is a traffic and navigation application and the active application currently displays an upcoming turn, RPM 226 may determine that the context of the active application indicates the driver will likely be interested in navigation information and will assign a high relevancy score to the navigation application (e.g., 95 out of 100). In some examples, RPM 226 may determine that relevancy score of one or more additional applications based on the context of the active application. For example, RPM 226 may assign a higher relevancy score to applications with a related context. For instance, if the active application is a navigation application and the information currently displayed by the navigation application includes a map to the driver's office, RPM 226 may assign a relatively high relevancy score to work related applications (e.g., a work calendar) and a relatively low relevancy score to unrelated applications. Similarly, if the information currently displayed by the navigation application includes a map to a recreational area (e.g., a beach), RPM 226 may assign a relatively high relevancy score to recreational related applications (e.g., a weather application).

In some examples, the context of the vehicle may include the past, current, or future physical location of the vehicle, whether the vehicle is moving or is stationary, speed of the vehicle, acceleration of the vehicle, traffic conditions, time of day, etc. For example, if the vehicle is accelerating rapidly, RPM 226 may determine that the context of the vehicle indicates that the driver will want to focus on driving and that other information may not be of interest to the driver. In other words, RPM 226 may determine that user attention span is reduced if the vehicle is accelerating rapidly (e.g., above a threshold acceleration). As a result, RPM 226 may determine that the relevancy scores associated with applications other than the active application are low and RPM 226 may refrain from causing PSD 212 from outputting a particular graphical user interface that may distract the driver. In another example, if the vehicle is located in the driver's driveway and the vehicle is not moving, RPM 226 may determine that the context of the vehicle indicates the driver may be interested in additional information and may assign a relatively high relevancy score to one or more additional applications.

As described above, RPM 226 may determine that the user attention span is reduced based on sensor components 252 and/or input components 244. For example, vehicle information system 200 may include a microphone that detects audio inputs, a camera that monitors the driver (e.g., monitoring body movement or eye movement), a camera that monitors traffic conditions surrounding the vehicle (e.g., by capturing images of nearby vehicles and/or traffic signs), a radar and/or lidar sensor to detect other vehicles, or any combination of the above. In some examples, RPM 226 may determine that the user attention span is reduced if the sensor components 252 detect heavy traffic, fast speeds, rapid acceleration, etc. In some examples, RPM 226 may determine that the user attention span is reduced if the input components 244 detect an unusual amount of body or eye movement (e.g., a low amount of eye movement which may indicate the driver is drowsy) or if the input components 244 detect a large amount of audio input (e.g., a large amount of audio input may indicate the driver is talking). In some examples, if RPM 226 determines the user attention span is reduced, RPM 226 may assign a low relevancy score (e.g., 0 out of 100) to one or more additional applications.

In some examples, the context of other applications may include how frequently a particular application presents information, how long a driver interacts with a particular application, or how frequently a driver interacts with a particular application. For example, if the context of a particular application indicates that the application frequently provides sports updates but that the user consistently ignores the updates, RPM 226 may determine that the user is not likely to be interested in the information and may assign a low relevancy score to the sports application (e.g., 10 out of 100). However, if the context of a particular application indicates that the driver frequently requests traffic information from a traffic application, RPM 226 may determine that the user is likely to be very interested in the traffic application and may assign a high relevancy score to the traffic application (e.g., 90 out of 100).

Contextual information may also include the context of the information itself. In some examples, the context of the information itself may include how recently the information was received. In other words, RPM 226 may determine a time at which the information associated with a particular application was received and may determine the relevancy score associated with the particular application based on the time at which the information was received. For example, if the information includes an incoming phone call, RPM 226 may determine that the user is very likely to be interested in the application and may determine that the relevancy score associated with the phone application is high (e.g., 100 out of 100). In another example, if the information includes an unread text message received over an hour ago, RPM 226 may determine that the user is not likely to be interested in the messaging application and may assign a relatively low (e.g., 30 out of 100) relevancy score to the messaging application. In some examples, the context of the information itself may include a priority of the information. For example, if the information includes an urgent severe weather warning from a weather application, RPM 226 may determine that the user is likely to be interested in the weather application and may assign a high relevancy score to the application. Conversely, if the information includes a calendar reminder for an event in two hours, RPM 226 may determine that the driver may be mildly interested in the calendar application and may assign a medium relevancy score to the calendar application (e.g., 55 out of 100). In some examples, an application may indicate whether a particular piece of information is likely to be of interest to the driver. For example, a phone application may indicate that an incoming call from a favorite contact is likely to be of interest to the driver but that an incoming call from an unknown number is unlikely to be of interest to the driver.

In some examples, RPM 226 may determine a relevancy score based on a single piece of contextual information. In other examples, RPM 226 may weight various pieces of contextual information in order to calculate the relevancy score. In some examples, RPM 22 may assign different weights to a given piece of contextual information at different days or times.

Responsive to determining a relevancy score for each application of the two or more applications, RPMI 226 may determine a highest ranked application of the two or more applications. For example, RPM 226 may sort the applications by relevancy score and may determine that the highest ranked application is the application with the largest relevancy score. For example, if the relevancy score for a phone application is 90 out of 100 and the relevancy score for a messaging application is 45 out of 100, RPM 226 may determine that the phone application has the largest relevancy score and, therefore, is the highest ranked application.

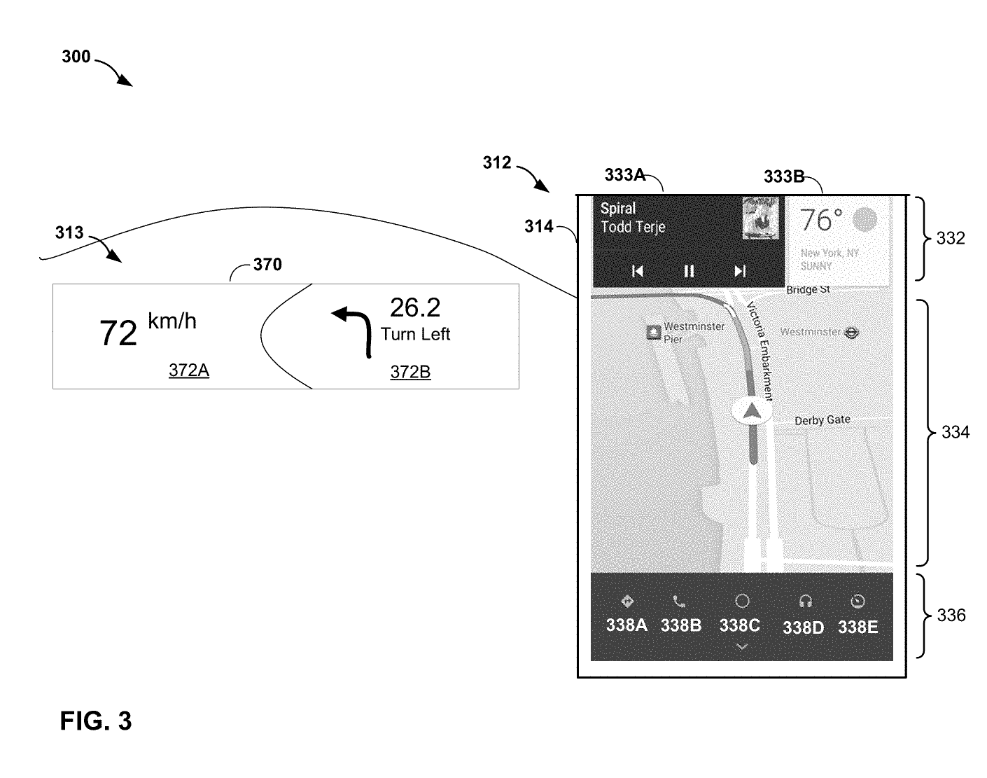

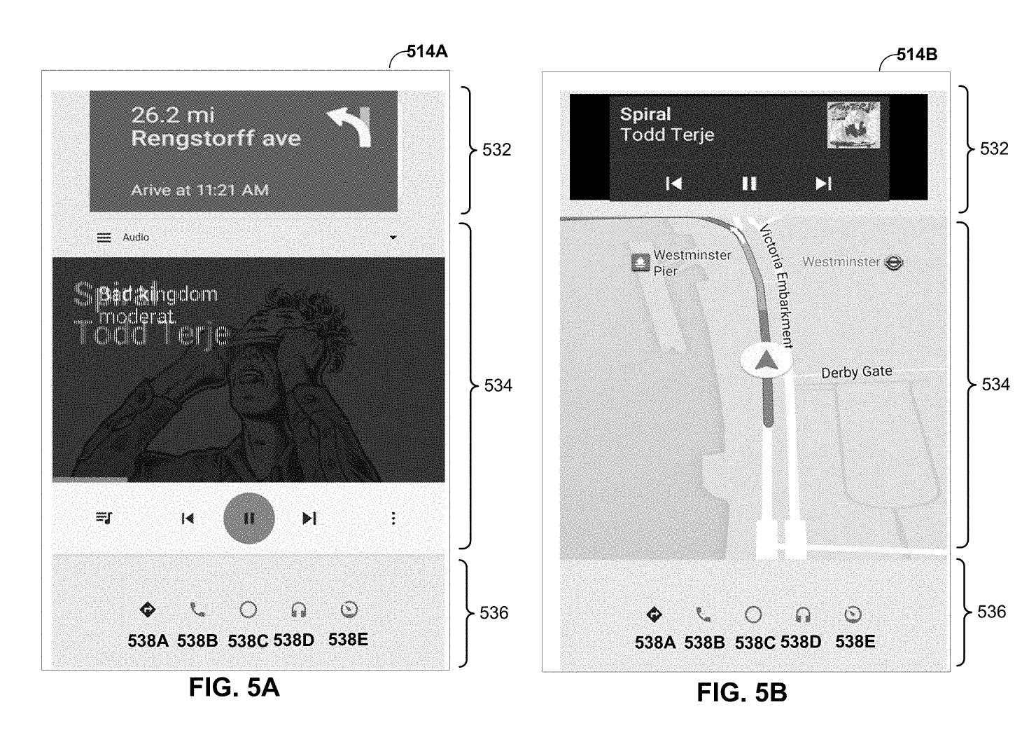

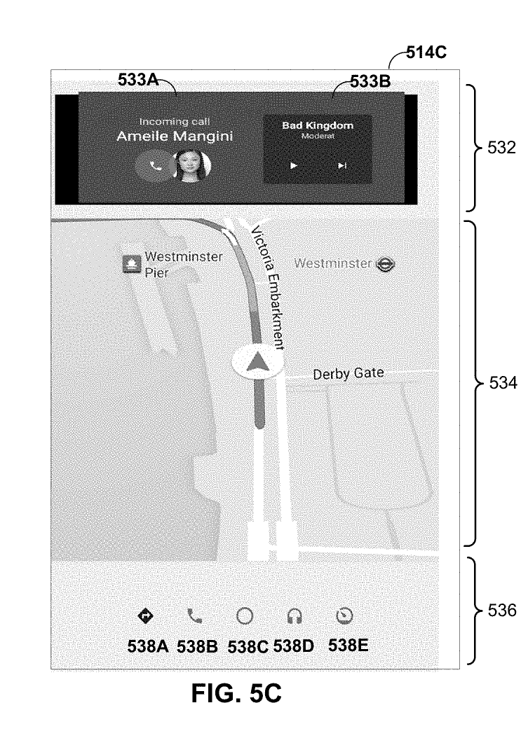

DMM 228 may determine whether and/or where to display a respective graphical user interface associated each of the applications. In some examples, DMM 228 may determine that PSD 212 should display a single graphical user interface in secondary application region 132 of the graphical user interface 114 of FIG. 1. In these examples, DMM 228 may output information associated with the highest ranked application (e.g., the phone application) to UI module 212. UI module 212 may receive information associated with the phone application from DMM 228 and may cause PSD 212 to display a graphical user interface associated with the phone application at secondary application region 132 of graphical user interface 114 of FIG. 1. In other examples, as described in more detail with reference to FIGS. 3 and 5C, DMM 228 may determine to output information associated with two or more applications and may determine where to output the information associated with each respective application of the two or more applications. In some examples, DMM 228 may determine that PSD 212 should not output a graphical user interface in secondary application region 132. For instance, as described above, if RPM 226 determines that the user attention span is reduced and sets a low relevancy score to the applications, DMM 228 may determine that the relevancy scores are less than a threshold relevancy score and may cause UI module 220 to output a blank graphical user interface at the secondary application region 132 of graphical user interface 114.

FIG. 3 is a conceptual diagram illustrating an example vehicle information system 300 that is configured to dynamically manage what and where information is presented to occupants of a vehicle, in accordance with one or more aspects of the present disclosure. Vehicle information system 300 may be an example of vehicle information system 100 or 200 of FIGS. 1 and 2, respectively. Vehicle information system 300 may include a plurality of display devices, such as a primary display device 312 located in the center console of a vehicle and one or more secondary display devices 313 located in a dashboard, a rear view mirror, one or more side mirrors, a heads-up display, a ceiling mounted display, mounted in or behind one or more seats, or in any other location of the vehicle where the presentation of information may be useful to occupants of a vehicle. In some examples, primary display device 312 (e.g., located in the center console of a vehicle) may display graphical user interface 314 and secondary display device 313 (e.g., located in a dashboard) may display graphical user interface 370.

Graphical user interface 370 may include a plurality of regions, such as instrument cluster region 372A and information region 372B (collectively, regions 372). Instrument cluster region 372A may be used to display information about the vehicle (e.g., a fuel gauge, speedometer, odometer, check engine light, etc.). Information region 372B may be used to display information associated with one or more applications of vehicle information system 300.

Responsive to RPM 226 of FIG. 2 determining what information to display, in some examples that include a primary display device 312 and secondary display device 313, DMM 228 may determine what information should be presented by primary display device 312 and by secondary display device 313. In some examples, DMM 228 may determine that secondary display device 313 is associated with certain applications and that primary display device 312 is associated with certain applications based on display rules data store 260. For example, display rules data store 260 may include a list of display devices and the applications that are associated with each respective display device in the list of display devices. DMM 228 may query display rules data store 260 to determine whether a particular application is associated with display device 313. For instance, display rules data store 260 may indicate that a mapping application is associated with secondary display device 313, a music application is associated with primary display device 313. In some instances, if display rules data store 260 does not include a particular application (e.g., a social media application), DMM 228 may determine that the social media application is not associated with either display device. In some instances, display rules data store 260 may only include a list applications associated with secondary display device 313, such that DMM 228 may determine that any other application not associated with secondary display device 313 is associated with primary display device 312.

In the example illustrated in FIG. 3, RPM 226 may determine the three highest ranked applications include a navigation application, a music application, and a weather application, in some examples, DMM 228 may query display rules data store 260 to determine whether each of the respective applications is associated with a particular display device and/or which display device each respective application is associated with. In some examples, display rules data store 260 may indicate that the navigation application is associated with secondary display 313 and that the music application and weather application are associated with primary display device 312. As a result, in some examples, in response to determining that a particular application (e.g., a navigation application) is associated with secondary display device 313, DMM 228 may send information to UI module 220 to cause secondary display device 313 to display a graphical user interface 370 that includes a graphical element associated with the navigation application at information region 372B of graphical user interface 370. Similarly, DMM 228 may send information to UI module 220 to cause primary display device 312 to display a graphical user interface 314 that includes a graphical element associated with the music application 333A and a graphical element associated with the weather application 333B at secondary application region 332.

In some examples, DMM 228 may determine that secondary display device 313 is associated with applications having a relevancy score within a certain range and that primary display device 312 is associated with applications have a relevancy score in a different range. For example, display rules data store 260 may include a list of display devices and a relevancy score range associated with each respective display device in the list of display devices. DMM 228 may receive a relevancy score for a particular application from RPM 226 and may query display rules data store 260 to determine which display device should output the information associated with the particular application. For instance, display rules data store 260 may indicate that a relevancy score within a first range (e.g., 81-100, out of 100) is associated with secondary display device 313, a relevancy score within a second range (e.g., 41-80, out of 100) is associated with primary display device 312, and that any other relevancy score is not associated with either display device. In some instances, display rules data store 260 may only include a range of relevancy scores associated with secondary display device 313, such that DMM 228 may determine that any other relevancy score not associated with secondary display device 313 is associated with primary display device 312.

In the example illustrated in FIG. 3, RPM 226 may indicate that a relevancy score for a navigation application is 90 out of 100, a relevancy score for a music application is 60 out of 100, and a relevancy score for a weather application is 50 out of 100. DMM may query display rules data store 260, which may indicate that a relevancy score of 90 out of 100 is associated with secondary display device 312 and that relevancy scores of 60 out of 100 and 50 out of 100 are associated with primary display device 312. As a result, in some examples, DMM 228 may send information to UI module 220 of FIG. 2 to cause secondary display device 313 to display a graphical user interface 370 that includes a graphical element associated with the navigation application at information region 372B of graphical user interface 370. Similarly, DMM 228 may send information to UI module 220 to cause music information associated with the music application 333A and the weather information associated with the weather application 333B to be displayed at secondary application region 332 of graphical user interface 314 of primary display device 312.

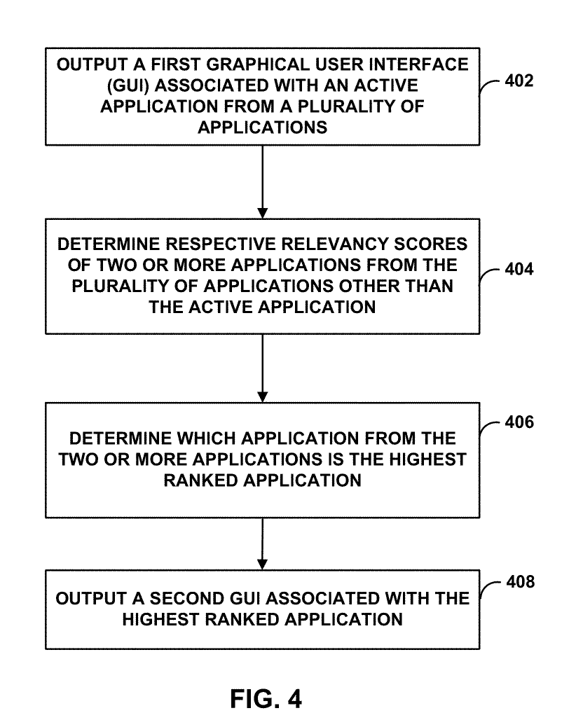

FIG. 4 is a flowchart illustrating example operations of a vehicle information system that is configured to dynamically manage what and where information is presented to occupants of a vehicle, in accordance with one or more aspects of the present disclosure. The process of FIG. 4 may be performed by one or more processors of a vehicle information system, such as vehicle information systems 100, 200 as illustrated in FIG. 1 and FIG. 2. For purposes of illustration only, FIG. 4 is described below within the context of vehicle information systems 100 and 200 of FIG. 1 and FIG. 2, respectively.

In the example of FIG. 4, an information system of a vehicle (e.g., vehicle information system 100), may output, for display at a first portion of a display device located at a center console of a vehicle information system, a first graphical user interface associated with an active application from a plurality of applications (402). For example, UI module 120 of vehicle information system 100 may output a graphical user interface associated with the active application (e.g., a navigation application) at the primary application region 134 of graphical user interface 114 of FIG. 1.

Vehicle information system 100 may determine a respective relevancy score of two or more applications (other than the active application) from the plurality of applications (404). In some examples, vehicle information system 100 may also determine a relevancy score of the active application. The respective relevancy scores may indicate a probability that the respective application will be of interest to a driver of the vehicle while the first graphical user interface is being output for display. In some examples, IMM 122 of vehicle information system 100 may determine the respective relevancy score of each application based on a type of the application, a context of the active application, a context of each application of the two or more applications, a context of the vehicle, or a combination therein. In some examples, IMM 122 may also determine the relevancy score based at least in part on information associated with the application. In some examples, vehicle information system 100 may include plurality of applications in addition to the active application, such as a weather application, a phone application, and a social media application. For purposes of illustration only, IMM 122 of vehicle information system 100 may determine that the relevancy scores of the weather application equals 50 out of 100, the relevancy score of the phone application equals 71 out of 100, and the relevancy score of the social media application equals 22 out of 100.

Vehicle information system 100 may determine which application from the two or more applications is the highest ranked application (406). In some examples, IMM 122 of vehicle information system 100 may make the determination based on the respective relevancy scores for each of the two or more applications. For example, IMM 122 of vehicle information system 100 may sort the two or more applications from largest relevancy score to smallest relevancy score, and may determine that the highest ranked application is the application with the largest relevancy score. Thus, continuing the example above, IMM 122 of vehicle information system 100 may determine that the phone application is the highest ranked application because the relevancy score for the phone application is greater than the relevancy score for any of the other applications.

In some examples, vehicle information system 100 may output a second GUI associated with the highest ranked application (408). For example, vehicle information system 100 may output the second GUI for display at a second portion of the display device. For instance, UI module 120 of vehicle information system 100 may output a graphical user interface associated with the phone application at secondary application region 132 of graphical user interface 114 of FIG. 1.

FIGS. 5A-5C are conceptual diagrams illustrating example graphical user interfaces output by an example vehicle information system that is configured to dynamically manage what and where information is presented to occupants of a vehicle, in accordance with one or more aspects of the present disclosure. FIGS. 5A-5C illustrate, respectively, example graphical user interfaces 514A-514C (collectively, graphical user interfaces 514). However, many other examples of graphical user interfaces may be used in other instances. Each of graphical user interfaces 514 may correspond to a graphical user interface output by vehicle information systems 100, 200 of FIGS. 1 and 2 respectively. FIGS. 5A-5C are described below in the context of vehicle information systems 100, 200 of FIGS. 1 and 2.

As illustrated in FIGS. 5A-5C, each example graphical user interface 514 includes secondary application region 532, primary application region 534, and icon region 536. Primary application region 534 may be used to display a graphical user interfaces associated with an active application and secondary application region 532 may be used to display a graphical user interface associated with a different application from a plurality of applications.

At a first time, RPM 226 of FIG. 2 may determine a relevancy score of two or more applications. In some examples, RPM 226 may determine the respective relevancy score of each application based on a type of the application, on the information associated with the application, a context of each application of the two or more applications, a context of the vehicle, or any combination therein. DMM 228 may determine where to display information associated with the two or more applications based on the relevancy scores. For example, as illustrated in FIG. 5A, DMM 28 may output an indication of where to display the information associated with the respective applications to UI module 220, which may cause PSD 212 to display a graphical user interface associated with a music application at primary application region 534 and a graphical user interface associated with a navigation application at secondary application region 532 of graphical user interface 514A.

In some examples, RPM 226 may periodically (e.g., at predefined time intervals (e.g., every 5 seconds, 10 seconds, 30 seconds, etc.) or when new information associated with a particular application is received) recalculate the relevancy scores associated with each application. In some examples, RPM 226 may calculate a relevancy score for the active application as well as one or more additional applications. For example, if primary application region 534 of graphical user interface 514A displays information associated with a music application (i.e., the music application is the active application) and secondary application region 532 displays information associated with a navigation application at the first time, and the vehicle is approaching a turn at a second time that is later than the first time, RPM 226 may recalculate the respective relevancy scores of the music application and the navigation application. For instance, RPM 226 may determine that the relevancy score for the navigation application is 80 out of 100 and that the relevancy score for the music application is 40 out of 100 at the second time.

RPM 226 may determine a highest ranked application from the active application displayed at primary application region 534 and at least one other application (e.g., an application displayed at secondary application region 532). RPM 226 may determine that the highest ranked application is the navigation application because the relevancy score for the navigation application is greater than the relevancy score for the music application. DMM 228 may determine that the highest ranked application should be displayed in primary application region 534. As a result, as illustrated by FIG. 5B, DMM 228 may update the graphical user interface by switching an application from the secondary application region to the primary application region, and vice versa. Thus, at the second time, UI module 220 may output a graphical user interface 514B that includes the navigation application at primary application region 534 and the music application at secondary application region 532. In other words, UI module 220 may output a graphical user interface associated with the highest ranked application (e.g., the navigation application) at the primary application region 534) and a graphical user interface associated with the active application (e.g., the music application) at the secondary application region 532.

In some examples, RPM 226 may recalculate the relevancy scores at a third time that is later than the second time. For example, vehicle information system 200 may receive an incoming call and RPM 226 may determine a relevancy score for the navigation application, the music application, and a phone application. In some examples, RPM 226 may determine that all three applications are likely to be of interest (e.g., the relevancy score for each application is greater than a threshold relevancy score) to the driver of the vehicle and that the graphical user interface should include information associated with all three applications.

In some examples, DMM 228 may receive an indication of each of the navigation application, the music application, and the phone application as well as the respective relevancy scores associated with each application. DMM 228 may determine where to output the information associated with each application. In some instances, if the relevancy score for the phone application and the relevancy score for the music application are both greater than a threshold relevancy score, DMM 228 may determine that the graphical user interface should include information associated with both the phone application and the music application. Thus, as illustrated in FIG. 5C, UI module 220 may output graphical user interface 514C, such that secondary application region 532 may include information associated with the phone application and the music application, and primary application region 534 may include information associated with the navigation application.

In some examples, DMM 228 may cause secondary application region 532 to include information associated with two or more applications, such as a graphical element associated with phone application 533A and a graphical element associated with music application 533B. DMM 228 may cause the graphical user elements associated with a particular application in secondary application region 532 to change, for example, by displaying fewer options. For instance, as illustrated in FIG. 53B, the graphical element associated with the music application displayed in secondary application region 532 includes three options buttons (e.g., reverse, pause, forward). However, as illustrated in FIG. 5C, because DMM 228 determined to display two applications in secondary application region 532, music application 533B includes two option buttons (e.g., play and forward).

The following numbered examples may illustrate one or more aspects of the disclosure:

### Example 1

A method comprising: outputting, by an information system of a vehicle, for display at a first portion of a display device located at a center console of the information system, a first graphical user interface (GUI) associated with an active application from a plurality of applications; determining, by the information system, respective relevancy scores of two or more applications from the plurality of applications other than the active application, wherein each respective relevancy scores indicates a probability that the application will be of interest to a driver of the vehicle while the first GUI is being output for display; determining, by the information system, based on the respective relevancy scores, a highest ranked application from the two or more applications; and outputting, by the information system, for display at a second portion of the display device, a second GUI associated with the highest ranked application.

### Example 2

The method of example 1, further comprising receiving, by the information system, an indication of a respective type of the two or more applications of the plurality of applications, wherein determining the respective relevancy scores of the two or more applications is based on the respective type of the two or more applications and a predefined ranking of application types.

### Example 3

The method of any combination of examples 1-2, further comprising determining, by the information system, a context of the active application, wherein determining the respective relevancy scores of the two or more applications is based on the context of the active application.

### Example 4

The method of example 3, wherein the context of the active application includes at least one of: an indication of application information associated with the active application previously displayed in the first portion of the first GUI, an indication of application information associated with the active application currently displayed in the first portion of the first GUI, or an amount of time that application information associated with the active application has been displayed in the first portion of the first GUI.

### Example 5

The method of any combination of examples 1-4, further comprising determining, by the information system, a context of the vehicle, wherein determining the respective relevancy scores of the two or more applications is based on the context of the vehicle.

### Example 6

The method of example 5, wherein the context of the vehicle includes at least one of: whether the vehicle is stationary or moving, a speed of the vehicle, an acceleration of the vehicle, a location of the vehicle, or time of day.

### Example 7

The method of any combination of examples 1-6, further comprising: receiving, by the information system, information associated with each respective application of the two or more applications; determining, by the information system, a respective time at which the information associated with the two or more applications was received, wherein determining the respective relevancy scores of the two or more applications is based on the respective time at which the information associated with the respective application of the two or more applications was received.

### Example 8

The method of any combination of examples 1-7, wherein the display device is a first display device, the method further comprising: determining, by the information system, from the first display device or a second display device of the information system, a particular display device at which to output a third GUI associated with at least one of the active application or a highest ranked application from the two or more applications; and responsive to determining that the particular display device is the second display device, outputting, by the information system, for display at the second display device, the third GUI associated with at least one of the active application or the highest ranked application from the two or more applications.

### Example 9

The method of example 8, wherein the second display device is located in a dashboard, rear view mirror, side mirror, or heads-up display.

### Example 10

The method of any combination of examples 8-9, wherein determining the particular display device at which to output the third GUI is based on at least one of: a first list of display devices and applications associated each respective display device in the first list of display devices, or a second list of display devices and a range of relevancy scores associated each respective display device in the second list of display devices.

### Example 11

The method of any combination of examples 1-10, further comprising: receiving, by the information system, an indication that the user attention span is reduced; and responsive to receiving the indication that the user attention span is reduced, outputting by the information system, for display at the second portion of the display, a third, blank GUI to replace the second GUI.

### Example 12

The method of any combination of examples 1-11, further comprising: determining, by the information system, a relevancy score of the active application; responsive to determining that the relevancy score of the active application is less than the relevancy score of the highest ranked application from the two or more applications: outputting, by the information system, a third GUI associated with the highest ranked application at the first portion of the display; and outputting, by the information system, a fourth GUI associated with the active application at the second portion of the display.

### Example 13

A vehicle information system comprising a computing device, the computing device comprising: a display device located at a center console of the vehicle information system; at least one processor; and a memory comprising instructions that, when executed by the at least one processor, cause the at least one processor to: output, for display at a first portion of the display device, a first graphical user interface (GUI) associated with an active application from a plurality of applications; determine respective relevancy scores of two or more applications from the plurality of applications other than the active application, wherein each respective relevancy scores indicates a probability that the application will be of interest to a driver of the vehicle while the first GUI is being output for display; determine, based on the respective relevancy scores, a highest ranked application from the two or more applications; and output, for display at a second portion of the display device, a second GUI associated with the highest ranked application.

### Example 14

The vehicle information system of example 13, wherein the memory comprises additional instructions that, when executed by the at least one processor, cause the at least one processor to: receive an indication of a respective type of the two or more applications of the plurality of applications, wherein the instructions that cause the at least one processor to determine the respective relevancy scores cause the at least one processor to determine the respective relevancy scores based on the respective type of the two or more applications and a predefined ranking of application types.

### Example 15

The vehicle information system of any combination of examples 13-14, wherein the memory comprises additional instructions that, when executed by the at least one processor, cause the at least one processor to: determine a context of the active application, wherein the instructions that cause the at least one processor to determine the respective relevancy scores cause the at least one processor to determine the respective relevancy scores based on the context of the active application, wherein the context of the active application includes at least one of: an indication of application information associated with the active application previously displayed in the first portion of the first GUI, an indication of application information associated with the active application currently displayed in the first portion of the first GUI, or an amount of time that application information associated with the active application has been displayed in the first portion of the first GUI.

### Example 16

The vehicle information system of any combination of examples 13-15, wherein the memory comprises additional instructions that, when executed by the at least one processor, cause the at least one processor to: determine, from the first display device or a second display device of the information system, a particular display device at which to output a third GUI associated with at least one of the active application or a highest ranked application from the two or more applications; and responsive to determining that the particular display device is the second display device, output, for display at the second display device, the third GUI associated with at least one of the active application or the highest ranked application from the two or more applications.

### Example 17

The vehicle information system of example 16, wherein the memory comprises additional instructions that, when executed by the at least one processor, cause the at least one processor to determine the particular display device at which to output the third GUI based on at least one of: a first list of display devices and applications associated each respective display device in the first list of display devices, or a second list of display devices and a range of relevancy scores associated each respective display device in the second list of display devices.

### Example 18

The vehicle information system of any combination of examples 13-17, wherein the memory comprises additional instructions that, when executed by the at least one processor, cause the at least one processor to: determine a relevancy score of the active application; responsive to determining that the relevancy score of the active application is less than the relevancy score of the highest ranked application from the two or more applications: output a third GUI associated with the highest ranked application at the first portion of the display; and output a fourth GUI associated with the active application at the second portion of the display.

### Example 19

A computer-readable storage medium encoded with instructions that, when executed by at least one processor of a computing device, cause the at least one processor to: output, for display at a first portion of a display device located at a center console of an information system of a vehicle, a first graphical user interface (GUI) associated with an active application from a plurality of applications; determine respective relevancy scores of two or more applications from the plurality of applications other than the active application, wherein each respective relevancy scores indicates a probability that the application will be of interest to a driver of the vehicle while the first GUI is being output for display; determine based on the respective relevancy scores, a highest ranked application from the two or more applications; and output, for display at a second portion of the display device, a second GUI associated with the highest ranked application.

### Example 20

The computer-readable storage medium of example 19, further comprising instructions that, when executed by the at least one processor, cause the at least one processor to: receive an indication of a respective type of the two or more applications of the plurality of applications, wherein the instructions that cause the at least one processor to determine the respective relevancy scores cause the at least one processor to determine the respective relevancy scores of the two or more applications based on the respective type of the two or more applications and a predefined ranking of application types.

### Example 21

A system comprising means for performing any of the methods of examples 1-12.

### Example 22

A computing device comprising means for performing any of the methods of examples 1-12.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
outputting, by an information system of a vehicle, for display at a first portion of a display device located at a center console of the information system, a first graphical user interface (GUI) associated with an active application from a plurality of applications;
determining, by the information system, respective relevancy scores of two or more applications from the plurality of applications other than the active application, wherein each respective relevancy scores indicates a probability that the application will be of interest to a driver of the vehicle while the first GUI is being output for display;
determining, by the information system, based on the respective relevancy scores, a highest ranked application from the two or more applications; and
outputting, by the information system, for display at a second portion of the display device, a second GUI associated with the highest ranked application.

2. The method of claim 1, further comprising receiving, by the information system, an indication of a respective type of the two or more applications of the plurality of applications,
wherein determining the respective relevancy scores of the two or more applications is based on the respective type of the two or more applications and a predefined ranking of application types.

3. The method of claim 1, further comprising determining, by the information system, a context of the active application,
wherein determining the respective relevancy scores of the two or more applications is based on the context of the active application.

4. The method of claim 3, wherein the context of the active application includes at least one of:
an indication of application information associated with the active application previously displayed in the first portion of the first GUI,
an indication of application information associated with the active application currently displayed in the first portion of the first GUI, or
an amount of time that application information associated with the active application has been displayed in the first portion of the first GUI.

5. The method of claim 1, further comprising determining, by the information system, a context of the vehicle,
wherein determining the respective relevancy scores of the two or more applications is based on the context of the vehicle.

6. The method of claim 5, wherein the context of the vehicle includes at least one of:
whether the vehicle is stationary or moving,
a speed of the vehicle,
an acceleration of the vehicle,
a location of the vehicle, or
time of day.

7. The method of claim 1, further comprising:
receiving, by the information system, information associated with each respective application of the two or more applications;
determining, by the information system, a respective time at which the information associated with the two or more applications was received,
wherein determining the respective relevancy scores of the two or more applications is based on the respective time at which the information associated with the respective application of the two or more applications was received.

8. The method of claim 1, wherein the display device is a first display device, the method further comprising:
determining, by the information system, from the first display device or a second display device of the information system, a particular display device at which to output a third GUI associated with at least one of the active application or a highest ranked application from the two or more applications; and
responsive to determining that the particular display device is the second display device, outputting, by the information system, for display at the second display device, the third GUI associated with at least one of the active application or the highest ranked application from the two or more applications.

9. The method of claim 8, wherein the second display device is located in a dashboard, rear view mirror, side mirror, or heads-up display.

10. The method of claim 8, wherein determining the particular display device at which to output the third GUI is based on at least one of:
a first list of display devices and applications associated each respective display device in the first list of display devices, or
a second list of display devices and a range of relevancy scores associated each respective display device in the second list of display devices.

11. The method of claim 1, further comprising:
receiving, by the information system, an indication that the user attention span is reduced; and
responsive to receiving the indication that the user attention span is reduced, outputting by the information system, for display at the second portion of the display, a third, blank GUI to replace the second GUI.

12. The method of claim 1, further comprising:
determining, by the information system, a relevancy score of the active application;
responsive to determining that the relevancy score of the active application is less than the relevancy score of the highest ranked application from the two or more applications:
outputting, by the information system, a third GUI associated with the highest ranked application at the first portion of the display; and
outputting, by the information system, a fourth GUI associated with the active application at the second portion of the display.

13. A vehicle information system comprising a computing device, the computing device comprising:
a display device located at a center console of the vehicle information system;
at least one processor; and
a memory comprising instructions that, when executed by the at least one processor, cause the at least one processor to:
output, for display at a first portion of the display device, a first graphical user interface (GUI) associated with an active application from a plurality of applications;
determine respective relevancy scores of two or more applications from the plurality of applications other than the active application, wherein each respective relevancy scores indicates a probability that the application will be of interest to a driver of the vehicle while the first GUI is being output for display;
determine, based on the respective relevancy scores, a highest ranked application from the two or more applications; and
output, for display at a second portion of the display device, a second GUI associated with the highest ranked application.

14. The vehicle information system of claim 13, wherein the memory comprises additional instructions that, when executed by the at least one processor, cause the at least one processor to receive an indication of a respective type of the two or more applications of the plurality of applications,
wherein the instructions that cause the at least one processor to determine the respective relevancy scores cause the at least one processor to determine the respective relevancy scores based on the respective type of the two or more applications and a predefined ranking of application types.

15. The vehicle information system of claim 13, wherein the memory comprises additional instructions that, when executed by the at least one processor, cause the at least one processor to determine a context of the active application,
wherein the instructions that cause the at least one processor to determine the respective relevancy scores cause the at least one processor to determine the respective relevancy scores based on the context of the active application, and
wherein the context of the active application includes at least one of:
an indication of application information associated with the active application previously displayed in the first portion of the first GUI,
an indication of application information associated with the active application currently displayed in the first portion of the first GUI, or
an amount of time that application information associated with the active application has been displayed in the first portion of the first GUI.

16. The vehicle information system of claim 13, wherein the memory comprises additional instructions that, when executed by the at least one processor, cause the at least one processor to:
determine, from the first display device or a second display device of the information system, a particular display device at which to output a third GUI associated with at least one of the active application or a highest ranked application from the two or more applications; and
responsive to determining that the particular display device is the second display device, output, for display at the second display device, the third GUI associated with at least one of the active application or the highest ranked application from the two or more applications.

17. The vehicle information system of claim 16, wherein the memory comprises additional instructions that, when executed by the at least one processor, cause the at least one processor to determine the particular display device at which to output the third GUI based on at least one of:
a first list of display devices and applications associated each respective display device in the first list of display devices, or
a second list of display devices and a range of relevancy scores associated each respective display device in the second list of display devices.

18. The vehicle information system of claim 13, wherein the memory comprises additional instructions that, when executed by the at least one processor, cause the at least one processor to:
determine a relevancy score of the active application;
responsive to determining that the relevancy score of the active application is less than the relevancy score of the highest ranked application from the two or more applications:
output a third GUI associated with the highest ranked application at the first portion of the display; and
output a fourth GUI associated with the active application at the second portion of the display.

19. A computer-readable storage medium encoded with instructions that, when executed by at least one processor of a computing device, cause the at least one processor to:
output, for display at a first portion of a display device located at a center console of an information system of a vehicle, a first graphical user interface (GUI) associated with an active application from a plurality of applications;
determine respective relevancy scores of two or more applications from the plurality of applications other than the active application, wherein each respective relevancy scores indicates a probability that the application will be of interest to a driver of the vehicle while the first GUI is being output for display;
determine based on the respective relevancy scores, a highest ranked application from the two or more applications; and
output, for display at a second portion of the display device, a second GUI associated with the highest ranked application.

20. The computer-readable storage medium of claim 19, further comprising instructions that, when executed by the at least one processor, cause the at least one processor to receive an indication of a respective type of the two or more applications of the plurality of applications,
wherein the instructions that cause the at least one processor to determine the respective relevancy scores of the two or more applications cause the at least one processor to determine the respective relevancy scores based on the respective type of the two or more applications and a predefined ranking of application types.
